(19) United States
(12) Patent Application Publication
(10) Pub. No.: US 2010/0273021 A1
(43) Pub. Date: Oct. 28, 2010

(54) Flexible retaining device for a profiling installation for the flexible roll forming of cold or hot profiles with a variable cross section

(76) Inventors: Stefan Freitag, Bavaria (DE); Albert Sedlmaier, Bavaria (DE); André Abee, Bavaria (DE)

Correspondence Address: Lisa Mueller;c/o Polsinelli Shughart PC, 161 N. Clark Street, Suite 4200, Chicago, IL, 60601, US

(21) Appl. No.: 12/670,327

(22) PCT Filed: Jul. 25, 2008
(86) PCT No.: PCT/EP08/06167

§ 371 Date: Jul. 6, 2010

(30) Foreign Application Priority Data
Jul. 25, 2007 (DE) 10 2007 034 708.3

(51) Int. Cl. B32B 1/00; B23Q 1/64; B21D 31/00

(52) U.S. Cl. 428/603; 269/56; 72/372

(57) ABSTRACT

A flexible retaining device (1) for a profiling installation for clamping a sheet metal (5) to be profiled is provided. Furthermore, a method for profiling a sheet metal (5) by using the flexible retaining device (1) is provided as well as sheet metal profiled with the method.

The invention refers to a flexible retaining device for a profiling installation for clamping a sheet metal to be profiled during roll forming of cold or hot profiles with variable cross sections, a corresponding method and a product manufactured with this method according to the preambles of Claim 1, Claim 10 and Claim 17, respectively.

### PRIOR ART

During roll forming, rollers cooperating in pairs provide for a profile, the form of which a sheet metal to be formed adopts. In general, forming of the sheet metal takes place in several steps with several roller pairs or roller stands. The step-by-step forming degree of the sheet metal is selected such that the sheet metal is not strained undesirably and deformed.

A device for producing profiled sheet metal with variable cross-sections is known from DE 100 11 755 A1. Therein there is disclosed a concept enabling, in addition to the conventional adjusting possibility transversely to the profiling direction, a rotational movement about the vertical axis. This concept is to eliminate the disadvantages of those functional principles where a tool movement is not possible in which the rollers contact the sheet metal tangentially during the entire profiling process. The adjustment of the rollers not only transversely to the profiling direction is to achieve flawless shaping and to eliminate undesired deformations of the sheet metal.

A similar device for producing profiled sheet metal with variable cross sections is known from DE 10 2004 040 257 A1. The device has an additional roller and a supporting element, where the rollers and supporting elements of the roller stand are intended to ensure that no undesired deformations occur on the sheet metal.

In spite of these provisions to achieve perfect shaping, undesired deformations may occur on the bottom of the sheet metal to be profiled and may lead to deviations from the ideal line of the bottom. The consequence of these undesired deformations is that no continually defined and controlled height of the bottom can be achieved. This leads to deviations from the ideal line of the bottom and to unacceptable product variations.

### OBJECT OF THE INVENTION

The object of the present invention is to eliminate the above mentioned drawbacks of the prior art in terms of the undesired deformations during flexible profiling and to provide a formed product with continually defined and controlled height of the bottom.

This object is achieved by a flexible retaining device for a profiling installation for clamping a sheet metal to be profiled during roll forming of cold or hot profiles with variable cross sections and by a corresponding method according to the preambles of Claim 1 and Claim 11, respectively.

Advantageous further developments of the invention are indicated in the appended claims.

### SHORT DESCRIPTION OF THE DRAWINGS

FIG. 1 shows a lateral view of a flexible retaining device according to the present invention.

FIG. 2 shows a perspective view of an upper assembly of the flexible retaining device of FIG. 1 with a displaceable upper clamping jaw 2a with an adjustable clamping pad 2b of the present invention.

FIG. 3 shows a perspective view of a flexible retaining device according to the present invention which is integrated in a profiling installation of the prior art.

### DETAILED DESCRIPTION OF PREFERRED EMBODIMENTS

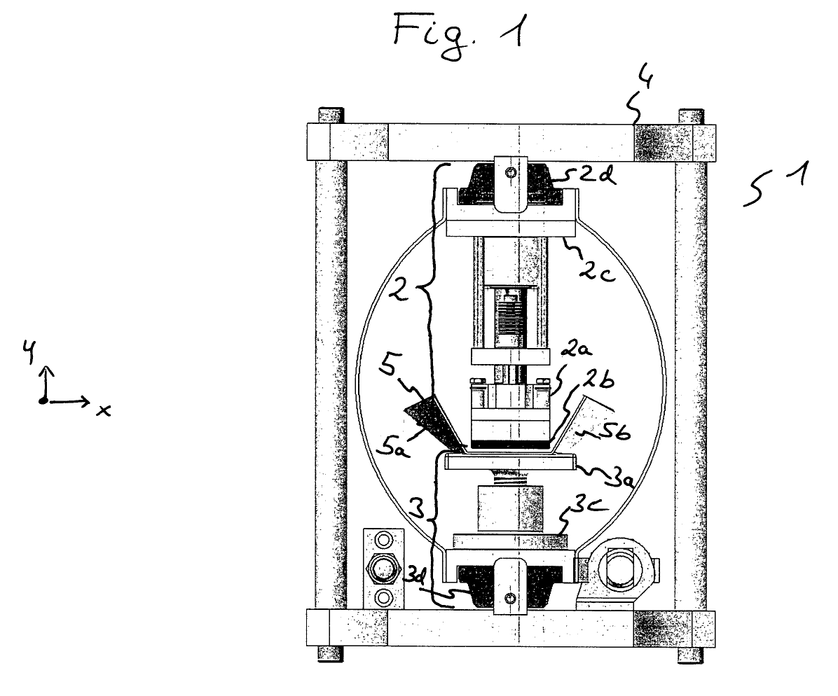

FIG. 1 shows a flexible retaining device 1 of the present invention for any profiling installation of the prior art. The retaining device 1 includes an upper assembly 2 and a lower assembly 3 clamping a sheet metal 5 to be profiled between them. The two assemblies 2, 3 are arranged movably within a frame 4 by means of an upper guide 2d and a lower guide 3d.

In one embodiment, the upper assembly 2 includes a holding fixture 2c and a displaceable upper clamping jaw 2a with an adjustable clamping pad 2b. The lower assembly 3 includes a holding fixture 3c and a displaceable lower clamping jaw 3a. The guides 2d, 3d can be embodied as rail guides. In another embodiment, the guides 2d, 3d can be embodied as roller guides. In a further embodiment, the guides 2d, 3d can be embodied as dovetail guides, prismatic guides, narrow guides or cylindrical guides. The shape of the upper guide 2d can differ from that of the lower guide 3d. Although not shown, a lower clamping pad, analogously to the upper clamping pad, can be provided which can be adapted in function like the upper clamping pad.

Advantageously, the displaceable upper clamping jaw 2a can be pressed onto the sheet metal 5 to be profiled and against the lower clamping jaw 3a by a hydraulic leverage in a direction perpendicular to the sheet metal feeding direction. In another embodiment, only the clamping jaw 2a is pressed against the sheet metal by a pneumatic or electromagnetic leverage, the lower clamping jaw 3a being adjustable to a predefined height by a screw.

In one embodiment, the assemblies 2, 3 of the flexible retaining device 1 clamp the sheet metal on both sides from above and below. In another embodiment, the assemblies 2, 3 clamp the sheet metal embracingly on one or both sides 5a, 5b.

In one embodiment, the assemblies 2, 3 of the flexible retaining device 1 are drawn along passively, i.e. with no separate drive via motors, with the sheet metal feed on the guides 2d, 3d within the frame 4. In this manner, no additional forces are introduced into the sheet metal during the profiling process so that 100% correspondence with the sheet metal feed is ensured. In another embodiment, the assemblies 2, 3 in the frame 4 are driven actively, i.e. with a separate drive via motors, on the guides 2d, 3d in the frame 4 in the direction of the sheet metal feed. However, in case of this active transport of the assemblies 2, 3, synchronization with the sheet metal feed is necessary. Also, combinations of active driving and passive drawing are considered by the invention.

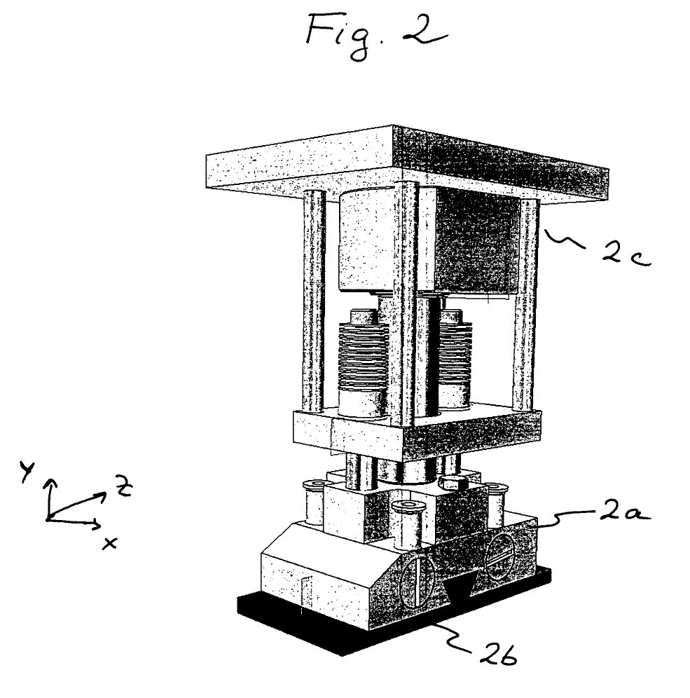

FIG. 2 shows an upper assembly 2 with a displaceable upper clamping jaw 2a having an adjustable clamping pad 2b of the present invention.

According to the invention, means are used for adjusting the clamping pad 2b during the profiling process in the feed plane (plane xz) or perpendicular to the feed plane (y direction). These means adapt the clamping pad 2b to the profile of the sheet metal in width, height, shape or position since in case of three-dimensional cross sections, i.e. with a bottom variable in height, the assembly 2 must follow the bottom of the profile and be adjusted in height and inclination. If the sheet metal is bent on different sides with respect to the bottom, it would be conceivable for these means to work on the respective sides of the bottom. By this adjustment, a collision with the sides 5a, 5b is avoided and the sheet metal is not subjected to undesired deformations.

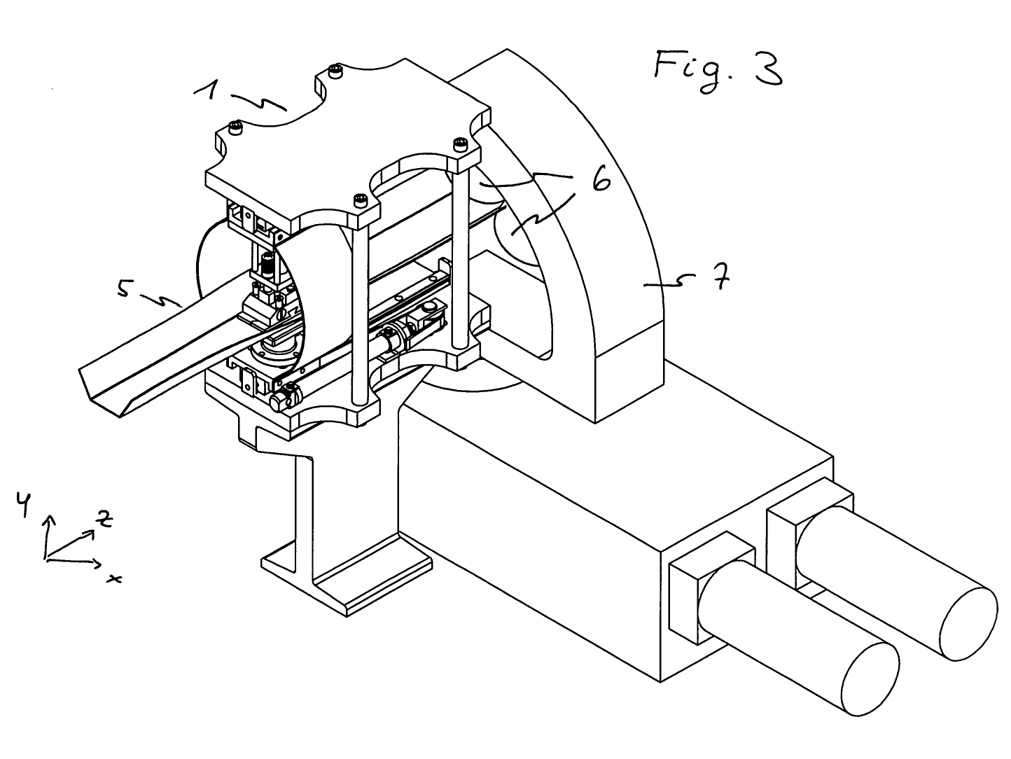

FIG. 3 shows a flexible retaining device 1 according to the present invention which is integrated in a profiling installation according to the prior art. A method for profiling a sheet metal 5 by using the flexible retaining device 1 includes the steps described in the following. Only one roller stand is shown in FIG. 3, but for the person skilled in the art, it is readily understandable that upstream and downstream of the roller stand, there are other roller stands which are part of a profiling installation.

In step 1, the sheet metal 5 to be profiled is clamped. For this purpose, the two assemblies 2, 3 press the profile of the sheet metal at a defined portion starting from an initial position (resting position). This predefined portion is determined in advance depending on the type of deformation and the sheet metal material used and also on the geometry of the roller device. The sheet metal is clamped on both sides from above and below. Alternatively, the sheet metal can be clamped embracingly on one or both sides 5a, 5b. During clamping of the sheet metal, it must be ensured that the pressing force is larger than the deformation force of the place to be clamped. Furthermore, all degrees of freedom, excepting the degree of freedom of the profiling direction, must be blocked so that no relative movement between the sheet metal and the retaining device is possible. Thus, undesired deformations of the sheet metal can be excluded and a continually defined and controlled height of the bottom can be achieved.

In step 2, the clamped sheet metal 5 is guided, during profiling, in the profiling direction with linear transport of the assemblies 2, 3. Thus, the assemblies 2, 3 move as one unit together with the sheet metal 5 to be profiled. The assemblies 2, 3 can be passively drawn along with the sheet metal feed. Introduction of additional forces into the sheet metal is avoided, and 100% correspondence with the sheet metal feed is ensured. Alternatively, the assemblies 2, 3 can be actively driven by motors in the direction of the sheet metal feed. In this case of transport of the assemblies 2, 3, however, a synchronization with the sheet metal feed is required. In this manner as well, undesired deformations of the sheet metal can be excluded and a continually defined and controlled height of the bottom can be achieved.

In this step 2, it is further preferred that the assemblies 2, 3 with the sheet metal clamped be brought as close as possible to the forming rollers 6 so as to have a guiding distance of the sheet metal as long as possible and a contact time with the sheet metal as long as possible.

Also, it is further preferred in this step 2 with three-dimensional cross sections, i.e. with height-variable bottoms, that the clamping pad 2b can be adjusted in width, height, shape or position to the profile of the sheet metal 5 during profiling. In this manner, a collision with the sides 5a, 5b is avoided. The assembly 2 can follow the bottom of the profile and adjust in height and inclination. In this manner as well, undesired deformations of the sheet metal can be excluded and a continually defined and controlled height of the bottom can be achieved.

In step 3, the clamping of the guided assemblies 2, 3 is released when the clamped portion reaches the next roller stand 7.

In step 4, the assemblies 2, 3 are returned to the initial position (resting position). After that, the steps 1-4 can be carried out again.

With the above described retaining device 1 of the present invention which can be integrated in a profiling installation according to the prior art, and with the method of the invention, sheet metal can be profiled which does not have the above mentioned disadvantages of the prior art. These sheet metal, having uniform quality due to a continually defined and controlled height of the bottom, can be manufactured, for instance, in the automotive industry, with the possibilities of application not being limited to this area.

If technical features mentioned in any of the claims are marked by a reference number, these reference numbers have been merely included to increase comprehensibility of the claims. Accordingly, these reference numbers have no limiting effect on the scope of each element identified by way of example by such reference numbers.

### LIST OF REFERENCE NUMBERS

1 flexible retaining device
2 upper assembly
2a displaceable upper clamping jaw
2b adjustable clamping pad
2c holding fixture
2d upper guide
3 lower assembly
3a displaceable lower clamping jaw
3c holding fixture
3d lower guide
4 frame
5 sheet metal to be profiled
5a side
5b side
6 forming rollers
7 roller stand

1. A flexible retaining device for clamping a sheet metal to be profiled comprising an upper assembly and a lower assembly which are arranged within a frame, clamp the sheet metal in a defined portion and are movable in a degree of freedom, wherein
the flexible retaining device is disposed before or after a roller stand of a profiling installation for roll forming of cold or hot profiles with a variable cross section, wherein both assemblies are arranged movably in the frame by means of an upper guide and a lower guide such as to move synchronously with the sheet metal feed for blocking all degrees of freedom excepting the degree of freedom of the profiling direction.

2. The flexible retaining device according to claim 1, wherein
the upper assembly comprises a holding fixture and a displaceable upper clamping jaw having an adjustable clamping pad, and
the lower assembly comprises a holding fixture and an displaceable lower clamping jaw.

3. The flexible retaining device according to claim 1,
wherein the guides comprise a rail guide, a roller guide, a dovetail guide, a prismatic guide, a narrow guide or a cylindrical guide.

4. The flexible retaining device according to claim 2, wherein the displaceable upper clamping jaw is pressed onto the sheet metal to be profiled and against the lower clamping jaw by hydraulic, pneumatic or electromagnetic leverage.

5. The flexible retaining device according to claim 1, wherein the assemblies clamp the sheet metal on both sides from above and below.

6. The flexible retaining device according to claim 1, wherein the assemblies clamp the sheet metal embracingly on one or both sides.

7. The flexible retaining device according to claim 1, wherein the assemblies in the frame are passively drawn along with the sheet metal feed.

8. The flexible retaining device according to claim 1, wherein the assemblies in the frame are actively driven in the direction of the sheet metal feed.

9. The flexible retaining device according to claim 1, further comprising means for adapting the clamping pad in width, height, shape or position to the profile of the sheet metal during the profiling process.

10. A method for profiling a sheet metal by using the flexible retaining device according to claim 1, the method comprising the following steps:
(1) clamping of the sheet metal with the two assemblies pressing the profile of the sheet metal in a defined portion starting from an initial position or resting position, the pressing force being greater than the deformation force of the clamped portion and all degrees of freedom excepting the degree of freedom of the profiling direction being blocked so that a relative movement between the sheet metal and the retaining device is prevented;
(2) guiding of the clamped sheet metal during profiling with linear transport of the assemblies in the profiling direction so that they move as a unit together with the sheet metal to be profiled;
(3) release of clamping of the transported assemblies when the clamped portion reaches a next roller stand; and
(4) returning the assemblies to the initial position or resting position.

11. The method according to claim 10, where in the step of guiding the sheet metal (step 2), the assemblies with the sheet metal clamped are brought as close as possible to the forming rollers.

12. The method according to claim 10, where in the step of clamping of the sheet metal (step 1), the sheet metal is clamped on both sides from above and below.

13. The method according to claim 10, where in the step of clamping of the sheet metal (step 1), the sheet metal is clamped embracingly on one or both sides.

14. The method according to claim 10, where in the step of transporting the assemblies (step 2), the assemblies are drawn along passively.

15. The method according to claim 10, where in the step of transporting the assemblies (step 2), the assemblies are actively driven in the direction of the sheet metal feed.

16. The method according to claim 10, where during the profiling process, the clamping pad can be adjusted to the profile of the sheet metal in width, height, shape or position.

17. A sheet metal profiled with the method according to claim 10.
